(19) United States
(12) Patent Application Publication
(10) Pub. No.: US 2017/0239871 A1
(43) Pub. Date: Aug. 24, 2017

(54) STRETCH BLOW MOULDING APPARATUS AND METHOD

(71) Applicant: The Queen's University of Belfast, Belfast (GB)

(72) Inventors: Gary Menary, Belfast (GB); Yannis Salomeia, Lisburn (GB); James Nixon, Belfast (GB); Shiyong Yan, Moneyreagh (GB)

(21) Appl. No.: 15/519,881

(22) PCT Filed: Oct. 21, 2015
(86) PCT No.: PCT/EP2015/074349

§ 371 Date: Apr. 18, 2017

(30) Foreign Application Priority Data
Oct. 22, 2014 (GB) 1418816.3

(51) Int. Cl. B29C 49/12; B29C 49/78; B29C 49/28

(52) U.S. Cl. CPC B29C 49/12; B29C 49/28; B29C 49/78; B29K 2067/003

(57) ABSTRACT

A stretch blow moulding apparatus for forming an article from a parison using a mould. The apparatus comprises a stretch rod assembly; an actuating mechanism for extending and retracting the stretch rod assembly in an axial direction; and a fluid injector for injecting pressurised fluid into the parison. The stretch rod assembly comprises a body and at least one deployable member located at a free end of the body. The body and the at least one deployable member are movable in the axial direction and the at least one deployable member is deployable laterally from the axial direction.

### FIELD OF THE INVENTION

The present invention relates to stretch blow moulding.

### BACKGROUND TO THE INVENTION

Stretch blow moulding of Polyethylene terephthalate (PET) has been ongoing for over 30 years and has been effective in forming thin-walled containers varying in shape and product requirement. A goal for both industry and research groups has been to engineer a successful bottle shape while reducing the amount of material required.

The stretch blow moulding of PET to form rigid, thin-walled containers may comprise a two part procedure; the linear stretching of a heated PET parison, or preform, followed by pressure inflation to form a desired shape, e.g. a bottle shape. It is the rapid stretching of the PET preform that results in an increase in material elastic modulus and allows for successful thin-walled containers that have to pass rigorous post-process testing such as top loading and burst testing. The linear stretching of the preform is conventionally achieved using a simple, solid rod, usually manufactured in steel. During contact between the stretch rod and the preform tip, not only does the material temperature dramatically reduce, but there is also almost zero material stretching. As a result of this lack of modulus increase, the mechanical properties of the bottom of the article are compromised and so to maintain the mechanical performance of the finished bottle an increased local thickness at the tip of the preform (which corresponds to the bottom of the bottle) is required.

It would therefore be beneficial to improve stretch blow moulding technology in order to stretch the tip of the preform to increase its modulus similar to that of the side walls of the container and so to remove the necessity to ‘add’ material at the bottom of the container. The overall weight of the preform would then be reduced and the potential material savings could be significant.

### SUMMARY OF THE INVENTION

A first aspect of the invention provides a stretch blow moulding apparatus for forming an article from a parison using a mould, the apparatus comprising: a stretch rod assembly; an actuating mechanism for extending and retracting the stretch rod assembly in an axial direction; and a fluid injector for injecting pressurised fluid into the parison, wherein said stretch rod assembly comprises a body and at least one deployable member located at a free end of said body, said body and said at least one deployable member being movable in said axial direction and said at least one deployable member being deployable laterally from said axial direction.

Typically, said stretch rod assembly comprises a plurality of said deployable members. The deployable members may be spaced apart, preferably substantially evenly, around the longitudinal axis of said body, said longitudinal axis being disposed substantially in said axial direction.

Said at least one deployable member may be pivotably coupled to said body for pivoting deployment with respect to the body.

Typically, the apparatus comprises an operating mechanism for deploying said at least one deployable member. In a preferred embodiment said body is hollow and contains an inner rod that is coaxial with the hollow body, the inner rod and hollow body being movable with respect to one another in the axial direction, and wherein the free end of the inner rod has a cam that projects from said free end of the body and engages with said at least one deployable member to provide said operating mechanism. Said stretch rod assembly may comprise a plurality of said deployable members and said cam is located between said deployable members. The configuration may be such that relative axial movement between the inner rod and the body that brings the cam towards said free end of the body causes said at least one member to deploy. The configuration may be such that relative axial movement between the inner rod and the body that moves the cam away from said free end of the body causes or allows said at least one deployable member to move towards a non-deployed state.

Optionally, the actuating mechanism is configured to selectably move the body and the inner rod together or separately in said axial direction.

Typically the apparatus includes a mounting block to which said parison and said mould are fitted, in use, such that the parison is located in a cavity formed in the mould, wherein said stretch rod assembly is extendible through said mounting block into said parison, and wherein at least one channel is formed in said mounting block having at least one outlet to allow said pressurised fluid to be injected into said parison.

Typically the apparatus includes a controller for controlling the operation of the actuating mechanism and the fluid injector. The controller may be configured to cause said stretch rod assembly to adopt initially a relatively retracted position with said at least one deployable member in a non-deployed state, and to move in said axial direction to a relatively extended position with said at least one deployable member maintained in, or substantially in, said non-deployed state. The stretch rod assembly may be extendible into said parison in use, and wherein in said relatively extended position the free end of said at least one deployable member is engagable with the end of the parison.

The controller may be configured to cause the stretch rod assembly to move in said axial direction from said relatively extended position to a further extended position.

The stretch rod assembly may be extendible into said parison in use, and said operating mechanism may be configured to cause said at least one deployable member to deploy when said stretch rod assembly is in a position in which the free end of said at least one deployable member engages with the end of the parison during deployment.

Said operating mechanism may be configured to simultaneously deploy said at least one deployable member while said stretch rod assembly moves from said relatively extended position to said further extended position. The deployment of said at least one deployable member and said movement of the stretch rod assembly to the further extended position may be effected by stopping extension of the inner rod in the axial direction while causing the body to continue to extend in the axial direction.

The controller may be configured to cause said stretch rod assembly to extend in said axial direction with said at least one deployable member deployed. Optionally, said controller is configured to cause said stretch rod assembly to extend in said axial direction from said further extended position to a still further extended position with said at least one deployable member deployed. The movement of the stretch rod assembly with said at least one deployable member deployed may be effected by extending the body and inner rod together, preferably with no relative axial movement, in the axial direction.

The stretch rod assembly may be extendible into said parison in use, and wherein the controller is configured cause the stretch rod assembly with said at least one deployable member deployed to push the stretched end of the parison onto the bottom surface of the mould cavity.

Typically, the lateral span between the ends of the deployable members when deployed substantially matches the dimensions of the bottom surface of the mould cavity.

The controller may be configured to cause said fluid injector to inject fluid into said parison simultaneously with the extension of said stretch-rod assembly in the axial direction and/or the deployment of said at least one deployable member.

A second aspect of the invention provides a stretch rod assembly for a stretch blow moulding apparatus, the stretch rod assembly comprising a body and at least one deployable member located at a free end of said body, said body and said at least one deployable member being movable in an axial direction and said at least one deployable member being deployable laterally from said axial direction.

A third aspect of the invention provides a stretch blow moulding method for forming an article from a parison using a mould and an apparatus as claimed in any one of claims 1 to 25, the method comprising: extending the stretch rod assembly into the parison in said axial direction; injecting pressurised fluid into said parison; positioning said at least one deployable member to engage with an end of said parison; deploying said at least one deployable member to stretch said base of said parison.

Preferred embodiments of the invention involve mechanically stretching the preform tip during the stretch-blow phase of the container formation.

Further advantageous aspects of the invention will be apparent to those skilled in the art upon review of the following description of specific embodiments and with reference to the accompanying drawings.

### BRIEF DESCRIPTION OF THE DRAWINGS

Embodiments of the invention are now described in which like numerals are used to denote like parts and in which:

FIG. 1 is a schematic diagram of a stretch blow moulding apparatus embodying one aspect of the invention;

FIGS. 2A to 2F show a respective view of a preferred stretch rod assembly embodying one aspect of the invention and suitable for use in the apparatus of FIG. 1, the respective views showing the stretch rod assembly in respective stages of deployment during a stretch blow process; and

FIGS. 3A to 3E show a respective view of an alternative stretch rod assembly embodying one aspect of the invention and suitable for use in the apparatus of FIG. 1, the respective views showing the stretch rod assembly in respective stages of deployment during a stretch blow process.

### DETAILED DESCRIPTION OF THE DRAWINGS

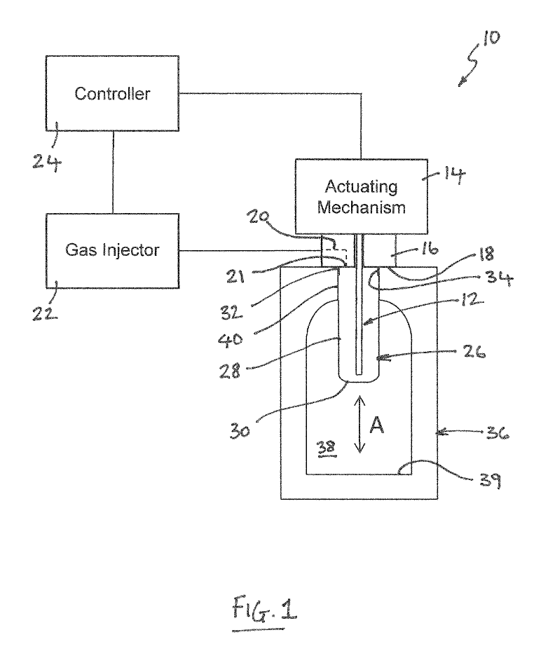

Referring now to FIG. 1 of the drawings there is shown, generally indicated as 10, a stretch blow moulding apparatus embodying one aspect of the invention. The apparatus 10 comprises a stretch rod assembly 12 that is movable in an axial direction (as indicated by arrow A in FIG. 1) by an actuating mechanism 14. The actuating mechanism 14 may be of any convenient conventional type and may be coupled to the stretch rod assembly 12 any convenient conventional manner.

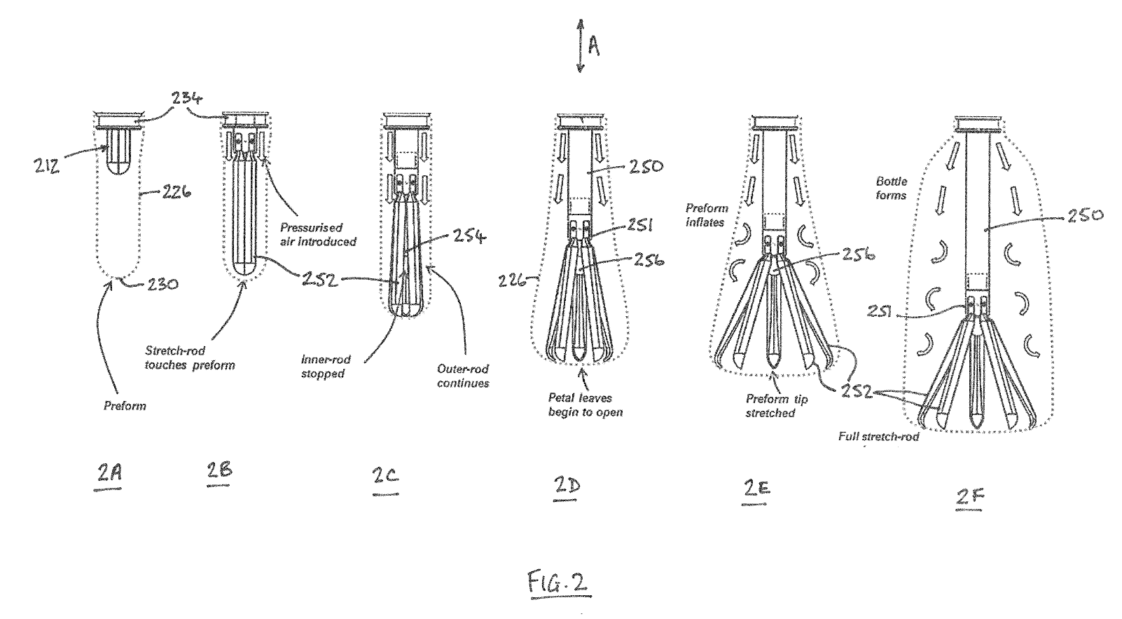

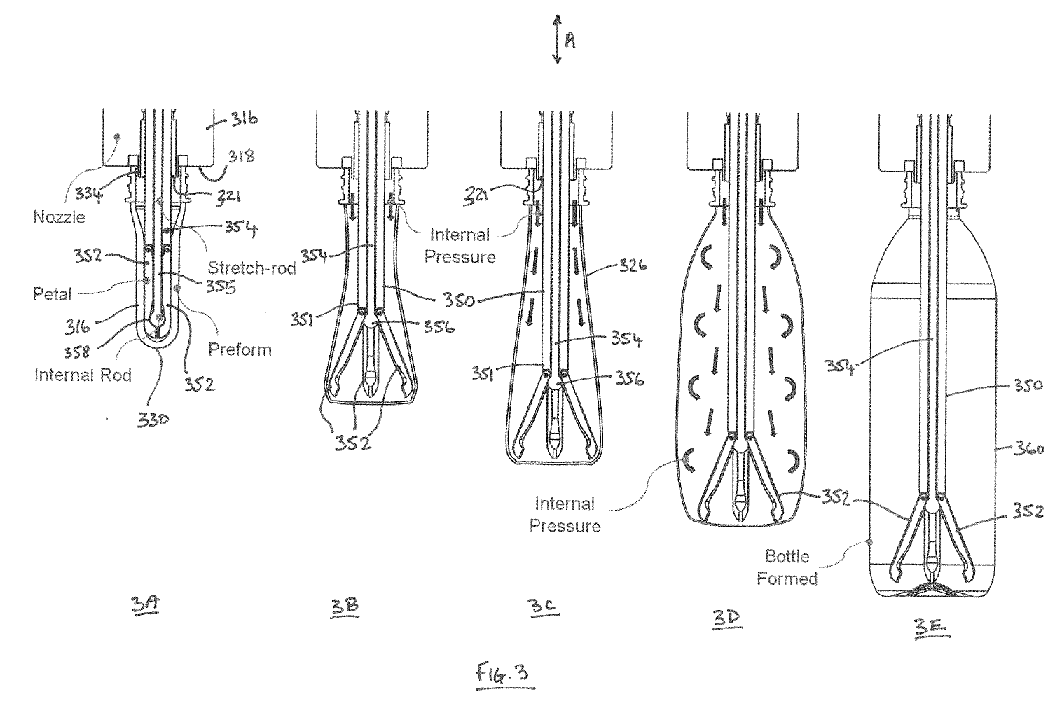

The stretch rod assembly 12 extends through a mounting block 16 (sometimes referred to as a die), and is movable with respect to the mounting block in the axial direction A. The stretch rod assembly 12 is movable axially between a retracted state (FIG. 2A) and a fully extended state (FIGS. 2F and 3E). The stretch rod assembly 12 emerges from the block 16 via an opening formed in an obverse face 18 of the block 16. In the retracted state the free end of the assembly 12 is relatively close to the obverse face of mounting block 16 while in the extended state the free end of the assembly 12 is relatively spaced apart from the obverse face of the mounting block 16.

At least one channel 20 is provided in the mounting block 16 to allow fluid to be injected through the block 16. The fluid may be gaseous, for example air, or may be liquid, for example water. The, or each, channel 20 has one or more outlets 21 that open onto the obverse face 18 of the block 16, typically adjacent the opening for the stretch rod assembly 12. In preferred embodiments, the channel outlet(s) are arranged to allow fluid to be expelled from the block 16 around the opening for the stretch rod assembly 12, e.g. by providing multiple channel outlets spaced apart around the stretch rod assembly opening, or providing one or more annular outlet(s) extending fully or partly around the stretch rod assembly opening.

A fluid injector 22 is connected to the, or each, channel 20 for the provision of pressurized fluid thereto. The fluid injector 22 may take any convenient conventional form, for example a gas compressor or a liquid compressor. By way of example, the fluid injector 22 may be configured to deliver fluid at a pressure of between approximately 2 bar and approximately 40 bar.

A controller 24 is provided for controlling the actuating mechanism 14 and the fluid injector 22. In particular the controller 24 controls the movement of the stretch rod assembly 12 and the injection of pressurised fluid through the block 16. The controller 24 may take any convenient conventional form, e.g. may comprise a suitably programmed microprocessor, microcontroller or logic controller (PLC), and may be connected to the actuating mechanism 14 and the fluid injector 22 in any conventional manner for the control thereof, typically for the provision of electrical control signals by a wired or wireless link.

In use, a parison 26 (also known as a preform) is fitted to the mounting block 16. The parison 26 comprises a hollow body 28, closed at one end 30 and open at the other end 32. The parison 26 is typically formed from a thermoplastic polymeric material, e.g. polyethylene terephthalate (PET). The parison 26 is fitted to the mounting block 16 such that the open end 32 surrounds the channel outlet(s) and the stretch rod assembly opening. To this end, the parison 26 is typically fitted to a collar 34 that is provided on the obverse face 18 of the block 16 around the channel outlet(s) and the stretch rod assembly opening. When the parison 26 is fitted, the stretch rod assembly 12 extends through the block 16 into the hollow body 28 of the parison 26 via its open end 32, and fluid injected through the block 16 is directed into the hollow body 28 via the open end 32. The fit is preferably fluid-tight such that fluid expelled from the block 16 during use is contained within the parison 26.

In use, a mould 36 is fitted to the apparatus 10. The mould 36 has an internal cavity 38 shaped and dimensioned according to the shape and dimension of an article (not shown in FIG. 1) to be formed. The article is typically a container, for example a bottle. The apparatus 10 may be used with a variety of different moulds thereby allowing a variety of different articles to be formed. The mould 36 is fitted to the mounting block 16 such that the parison 26 is located inside the mould 36. Typically, the parison 26 includes a neck portion 40 adjacent its open end 32 that is not required to be blown or stretched by the apparatus 10. Accordingly, the configuration is such that only the portion of the body 28 between the neck 40 and the end 30 is located in the cavity 38. The neck 40 may be preformed with screw threads around its outer surface for receiving a lid (not shown).

In typical embodiments, the parison 26 is preformed and provided for use by the apparatus 10 in a cooled, rigid state. Before the parison 26 can be blown and stretched by the apparatus 10 it is heated to, or above, its glass transition temperature. This may be achieved using any convenient conventional parison heating device (not illustrated), which is typically separate from the apparatus 10, the parison 26 being fitted to the apparatus 10 after heating. In alternative embodiments, the apparatus 10 may include a heating device for this purpose.

FIGS. 2 and 3 show respective preferred embodiments of the stretch rod assembly 212, 312. The stretch rod assemblies 212, 312 are similar to one another and so like numerals are used to denote like parts and the same or similar description applies, as would be apparent to a skilled person, unless otherwise stated. In FIG. 2, the assembly 212 is shown in side view and the mounting block is not shown. In FIG. 3, the assembly 312 is shown in side section and the mounting block 316 is shown.

The stretch rod assembly 212, 312 comprises a body 250, 350, which in the illustrated embodiments is elongate, having a longitudinal axis disposed in the axial direction A, and which is movable back and forth in the axial direction A by the actuating mechanism 14. The assembly 212, 312 further includes a plurality of deployable members, which in the illustrated embodiment comprise arms 252, 352, that are deployable laterally from the axial direction A. In particular, each arm 252, 352 is deployable between a non-deployed state (FIGS. 2A, 2B and 3A) and a fully deployed state (FIGS. 2E, 2F and 3B to 3E). In the non-deployed state, each arm 252, 352 adopts a position in which it is relatively close to the longitudinal axis of the body 250, 350, preferably being disposed such that it is substantially aligned with (i.e. substantially in line or parallel with) the longitudinal axis of the body 250, 350. In the fully deployed state, each arm 252, 352 adopts a position in which it is relatively extended (laterally) from the longitudinal axis of the body 250, 350. In preferred embodiments, each arm 252, 352 has one end pivotably coupled to the body 250, 350 (e.g. by means of a respective hinge), the other end being free. In the non-deployed state the free end is relatively close to the longitudinal axis of the body 250, 350, while in the deployed state the free end is relatively displaced from the longitudinal axis of the body 250, 350. In any event, it is preferred that, in the deployed state, the arms 252, 352 are splayed with respect to each other and with respect to the longitudinal axis of the body, while in the non-deployed state they are not, or are at least less splayed. FIGS. 2C and 2D show the arms 252 in respective intermediate deployed states between the non-deployed and fully deployed states.

Typically, the arms 252, 352 are located at the end of the body 250, 350 such that they provide the free end of the stretch rod assembly 212, 312. Accordingly, the free ends of the arms 252, 352 engage with the parison 226, 336, and in particular its end 230, 330, during use, as is described in more detail hereinafter.

In the embodiment of FIG. 2, the assembly 212 has five arms 252, while in the embodiment of FIG. 3, the assembly 312 has four arms 352 (only three shown), although this is not limiting to the invention. More generally stretch rod assemblies embodying the invention have at least one but preferably a plurality of deployable members which may take any suitable form, e.g. arms, wires, bands or strips. It will be understood that descriptions herein relating to arms 252, 352 may be applied equally to other deployable members in alternative embodiments. It is preferred to have a plurality of arms spaced apart, preferably substantially evenly, around the longitudinal axis of the assembly.

The apparatus 10 includes an operating mechanism for moving the arms 252, 352 between the non-deployed and deployed states. The operating mechanism may take any convenient form. For example, it may be power-operated (e.g. by one or more electric motors and/or actuators (not shown)) under the control of the controller 24. In preferred embodiments, however, the operating mechanism is mechanical, incorporated into the stretch rod assembly. In the illustrated embodiments, the stretch rod assembly is configured such that axial movement of the stretch rod assembly 212, 312 towards its extended state selectably causes the arms 252, 352 to deploy, and axial movement of the stretch rod assembly 212, 312 towards its retracted state selectably causes or allows the arms 252, 352 to close towards the non-deployed state.

To this end, in preferred embodiments the body 250, 350 is sleeve-like and contains an inner rod 254, 354 that is coaxial with the hollow body 250, 350. The inner rod 254, 354 and hollow body 250, 350 are movable in the axial direction A not only together but also with respect to one another. The inner rod 254, 354 has a cam 256, 356 at its free end. The cam 256, 356 conveniently comprises a ball or other bulbous formation. The free end 251, 351 of the body 250, 350 is open and a portion 255, 355 of the inner rod 254, 354 including its free end and cam 256, 356 may project therefrom, the extent of the projection depending on the relative axial movement between the inner rod 254, 354 and the body 250, 350. The arrangement may be such that the projecting portion 255, 355 including the cam 256, 356 is located within the arms 252, 352.

The cam 256, 356 interacts with the arms 252, 352 to cause the arms 252, 352 to move between the deployed and non-deployed states depending on the direction of the relative axial movement between the inner rod 254, 354 and the body 250, 350. In particular the cam 256, 356 is located within the arms 252, 352 and engages with one or more inner surfaces of the arms 256, 356 to effect movement of the arms 252, 352 as a result of relative axial movement between the inner rod 254, 354 and the body 250, 350. In preferred embodiments the relative axial movement between the inner rod 254, 354 and the body 250, 350 effects pivoting movement of the arms 252, 352. Relative axial movement that brings the cam 256, 356 towards the end 251, 351 of the body 250, 350 causes the arms 252, 352 to deploy, and relative axial movement that moves the cam 256, 356 away from the end 251, 351 of the body 250, 350 causes or allows the arms 252, 352 to move towards the non-deployed state. Conveniently, the stretch rod assembly 212, 312 is oriented in use such that the arms 252, 352 tend to move towards the non-deployed state under the influence of gravity. Alternatively, or in addition, one or more arm closing devices (not illustrated), such as one or more actuator or one or more resilient biasing device (e.g. spring) or a magnetic closing device is provided for this purpose. In preferred embodiments, when the cam 256, 356 is in its farthest position from the end 251, 351 of the body 250, 350 the arms 252, 352 adopt the non-deployed state and when the cam 256, 356 is in its closest position to the end 251, 351 of the body 250, 350 the arms 252, 352 adopt the fully deployed state.

For example FIG. 3A shows the arms 352 in their non-deployed state, the rod portion 355 projecting from the free end 351 of the body 350 and being located within the non-deployed arms 352, preferably such that the cam 356 is located substantially at the free ends of the arms 352 (i.e. the relative travel of the portion 355 is approximately the same length as the arms, 352). Preferably, the arms 352 are shaped to define a seat 358 for receiving the cam 356 in this state. FIG. 3B shows the arms 352 in their fully deployed state, with only the cam 356 projecting from the free end 351 of the body 350 and being located within the non-deployed arms 352, preferably such that the cam 356 is located substantially at the free end 351 of the body 350.

The actuating mechanism 14 is configured to move the body 250, 350 and the inner rod 254, 354 together or to be moved separately, and may be coupled to the stretch rod assembly 212, 312 in any convenient conventional manner. This may be achieved using any convenient conventional actuating means. For example, the actuating mechanism 14 may comprise a respective independently operable actuator (not shown) for moving the body 250, 350 and the inner rod 254, 354. The or each actuator may for example comprise a linear actuator, typically an electrically operable linear actuator.

In alternative embodiments (not illustrated) alternative mechanical or electro-mechanical deployment mechanisms may be used. For example, the operating mechanism may comprise a central rod about which the deployable members are located. The rod may be screw threaded and carry a correspondingly threaded displacement component that travels along the rod when the rod is rotated about its longitudinal axis, the direction of travel being determined by the direction of rotation of the rod and the sense of the screw thread. The displacement component engages with the displacement members and deploys them from the rod by an amount that depends on the position of the displacement member on the rod. Typically the deployable members are pivotably coupled to the rod.

The preferred operation of the apparatus 10 is now described with particular reference to the stretch rod assemblies 212, 312 of FIGS. 2 and 3. Initially, the stretch rod assembly 212, 312 is in a relatively retracted position (e.g. the retracted state shown in FIG. 2A) and the arms 252, 352 are in the non-deployed state. In preferred embodiments, this corresponds to the rod portion 355 being relatively extended from the end 251, 351 of the body 250, 350, typically in its most extended position as for example shown in FIG. 3A. The parison 226, 326 is fitted to the mounting block 316 in particular to the collar 234, 334. The end the stretch rod assembly 212, 312 is located inside the parison 226, 326.

With the arms 252, 352 preferably maintained in the non-deployed state, the stretch rod assembly 212, 312 is extended in the axial direction, until its end reaches and preferably engages with the internal end 230, 330 of the parison 226, 326 (FIGS. 2A and 3A). In preferred embodiments, this corresponds to the body 250, 350 and inner rod 254, 354 being moved together by the actuating mechanism 14 with no relative axial movement. In alternative embodiments, a relatively small degree of arm deployment may take place during this operation but not so much that the arms engage with the inner sides of the parison 226, 336. As such there may be a little relative axial movement between the body 250, 350 and inner rod 254, 354.

Next, the stretch rod assembly 212, 312 is further extended in the axial direction and the arms 252, 352 are simultaneously deployed (FIGS. 2C to 2E, 3B and 3C). In preferred embodiments this involves stopping extension of the inner rod 254, 354 in the axial direction while causing the body 250, 350 to continue to extend in the axial direction. As a result, the arms 252, 352 are deployed by engagement with the cam 256, 356 as the body 250, 350 moves axially relative to the cam 256, 356. Extension of the stretch rod assembly 212, 312 in the axial direction causes the parison 226, 326 to be stretched in the axial direction. Deployment of the arms 252, 352 causes the ends of the arms to stretch the end 230, 330 of the parison 226, 326 laterally by engagement therewith.

When the arms 252, 352 have reached the fully deployed state, the stretch rod assembly 212, 312 may be further extended in the axial direction to further stretch the parison 226, 326 (FIGS. 2F, 3D and 3E). In preferred embodiments, this involves extending the body 250, 350 and inner rod 254, 354 together, preferably with no relative axial movement, in the axial direction. Whether or not such further extension is required may be determined by the shape and/or dimensions of the article being formed. In any event, the stretch rod assembly 212, 312 extends in the axial direction, with the arms 252, 352 deployed, until the end of the parison 226, 326 is pushed onto the bottom surface 39 of the mould cavity 38. It is preferred that the lateral span between the ends of the arms 252, 352 when deployed substantially matches the dimensions of the bottom surface 39 of the cavity 38 such that the deployed arms 252, 352 stretch the end 230, 330 of the parison 226, 326 to cover the bottom surface 39. It will be apparent that, depending on the dimensions of the mould cavity 38, the arms 252, 352 may not reach their fully deployed state during the stretching process.

In addition to stretching by the stretch rod assembly 212, 312, the article 360 (which in the example of FIG. 3 is a bottle) is formed by injecting fluid, typically air, under pressure into the parison 226, 326. The fluid is provided by the fluid injector 22 through the channel(s) 20 and enters the parson 226, 326 via channel outlet(s) 221, 321. The timing of the fluid injection may vary depending on the article being formed, i.e. the fluid may be injected before, during and/or after stretching of the parison by the stretch rod assembly. In the illustrated embodiment, the injection of fluid (and consequent inflation of the parison 226, 326) may occur simultaneously with the stretching effected by the stretch-rod assembly, although the relative timing of the injection of fluid and stretching effected by the stretch-rod assembly may be varied. For example, the fluid may be injected once the end of the stretch rod assembly 212, 312 engages with the inner end of the parison 226, 326, and this may be simultaneous with the beginning of the stretching process by extension of the stretch rod assembly 212, 312. The fluid injection preferably continues while the arms 252, 352 deploy and the stretch rod assembly 212, 312 extends. By way of example, when the parison 226, 336 is being stretched the fluid may be injected into the parison at approximately 10 bar. Subsequently, the fluid may be injected at approximately 40 bar when the stretch phase is complete in order to form ribs and bottle feet, if required.

Accordingly, a combination of stretching by the stretch rod assembly 212, 312 and inflation by the injected fluid causes the parison 226, 326 to conform to the shape and dimensions of the mould cavity 38. In preferred embodiments, the action of the deployed arms 252, 352 stretches the end of the parison 226, 326 thereby increasing its elastic modulus and mechanical performance such that it is similar to that of the rest of the parison 226, 326. This may remove, or at least reduce, the necessity to provide additional material the end of the parison 226, 326 to compensate for under-stretching, i.e. to provide the bottom of the article 360 being formed with the desired physical properties. Using less material to form the parison 226, 326 can result in significant cost savings, especially in cases where the article 360, e.g. a bottle, is produced in large quantities.

Once the article has been formed, the stretch rod assembly 212, 312 may be retracted, and the arms 252, 352 closed. The finished article 360 may then be removed from the apparatus 10 and mould 36.

In alternative embodiments (not illustrated), the arms (or other deployable members) need not necessarily be pivotable to deploy. For example the deployable members may be flexible, optionally resiliently flexible, and as such deployable by bending. Alternatively, the deployable members may be deployable by non-pivoting lateral displacement, and any conventional actuating device may be used for this purpose.

The relative timing between the deployment of the arms and the injection of pressurised fluid may be varied to suit one or more required characteristics, e.g. the thickness of the side wall, of the container.

The invention is not limited to the embodiment(s) described herein but can be amended or modified without departing from the scope of the present invention.

1. A stretch blow moulding apparatus for forming an article from a parison using a mould, the apparatus comprising:
a stretch rod assembly;
an actuating mechanism for extending and retracting the stretch rod assembly in an axial direction; and
a fluid injector for injecting pressurised fluid into the parison,
wherein said stretch rod assembly comprises a body and at least one deployable member located at a free end of said body, said body and said at least one deployable member being movable in said axial direction and said at least one deployable member being deployable laterally from said axial direction.

2. The apparatus of claim 1, wherein said stretch rod assembly comprises a plurality of said deployable members, said plurality of said deployable members being spaced apart, preferably substantially evenly, around the longitudinal axis of said body, said longitudinal axis being disposed substantially in said axial direction.

3. (canceled)

4. The apparatus of claim 1, wherein said at least one deployable member is pivotably coupled to said body for pivoting deployment with respect to the body.

5. The apparatus of claim 1, comprising an operating mechanism for deploying said at least one deployable member.

6. The apparatus of claim 5, wherein said body is hollow and contains an inner rod that is coaxial with the hollow body, the inner rod and hollow body being movable with respect to one another in the axial direction, and wherein the free end of the inner rod has a cam that projects from said free end of the body and engages with said at least one deployable member to provide said operating mechanism.

7. The apparatus of claim 6, wherein said stretch rod assembly comprises a plurality of said deployable members and said cam is located between said deployable members.

8. The apparatus of claim 6, wherein relative axial movement between the inner rod and the body that brings the cam towards said free end of the body causes said at least one member to deploy.

9. The apparatus of claim 6, wherein relative axial movement between the inner rod and the body that moves the cam away from said free end of the body causes or allows said at least one deployable member to move towards a non-deployed state.

10. The apparatus of claim 6, wherein the actuating mechanism is configured to selectably move the body and the inner rod together or separately in said axial direction.

11. The apparatus of claim 1, further including a mounting block to which said parison and said mould are fitted, in use, such that the parison is located in a cavity formed in the mould, wherein said stretch rod assembly is extendible through said mounting block into said parison, and wherein at least one channel is formed in said mounting block having at least one outlet to allow said pressurised fluid to be injected into said parison.

12. The apparatus of claim 1, further including a controller for controlling the operation of the actuating mechanism and the fluid injector.

13. The apparatus of claim 12, wherein said controller is configured to cause said stretch rod assembly to adopt initially a relatively retracted position with said at least one deployable member in a non-deployed state, and to move in said axial direction to a relatively extended position with said at least one deployable member maintained in, or substantially in, said non-deployed state.

14. The apparatus of claim 13, wherein said stretch rod assembly is extendible into said parison in use, and wherein in said relatively extended position the free end of said at least one deployable member is engagable with the end of the parison.

15. The apparatus of claim 13, comprising an operating mechanism for deploying said at least one deployable member, and wherein said body is hollow and contains an inner rod that is coaxial with the hollow body, the inner rod and hollow body being movable with respect to one another in the axial direction, and wherein the free end of the inner rod has a cam that projects from said free end of the body and engages with said at least one deployable member to provide said operating mechanism, and wherein said movement to said relatively extended position involves movement of the body and inner rod together in said axial direction, with no or substantially no relative axial movement.

16. The apparatus of claim 13, wherein said controller is configured to cause the stretch rod assembly to move in said axial direction from said relatively extended position to a further extended position.

17. The apparatus of claim 5, wherein said stretch rod assembly is extendible into said parison in use, and wherein said operating mechanism is configured to cause said at least one deployable member to deploy when said stretch rod assembly is in a position in which the free end of said at least one deployable member engages with the end of the parison during deployment.

18. The apparatus of claim 17, wherein said stretch rod assembly is extendible into said parison in use, and wherein said operating mechanism is configured to cause said at least one deployable member to deploy when said stretch rod assembly is in a position in which the free end of said at least one deployable member engages with the end of the parison during deployment, and wherein said operating mechanism is configured to simultaneously deploy said at least one deployable member while said stretch rod assembly moves from said relatively extended position to said further extended position.

19. The apparatus of claim 18, comprising an operating mechanism for deploying said at least one deployable member, and wherein said body is hollow and contains an inner rod that is coaxial with the hollow body, the inner rod and hollow body being movable with respect to one another in the axial direction, and wherein the free end of the inner rod has a cam that projects from said free end of the body and engages with said at least one deployable member to provide said operating mechanism, and wherein said deployment of said at least one deployable member and said movement of the stretch rod assembly to the further extended position are effected by stopping extension of the inner rod in the axial direction while causing the body to continue to extend in the axial direction.

20. The apparatus of claim 12, wherein said controller is configured to cause said stretch rod assembly to extend in said axial direction with said at least one deployable member deployed.

21. The apparatus of claim 20, wherein said controller is configured to cause the stretch rod assembly to move in said axial direction from said relatively extended position to a further extended position, and wherein said controller is configured to cause said stretch rod assembly to extend in said axial direction from said further extended position to a still further extended position with said at least one deployable member deployed.

22. The apparatus of claim 20, wherein said controller is configured to cause the stretch rod assembly to move in said axial direction from said relatively extended position to a further extended position, and wherein said movement of the stretch rod assembly with said at least one deployable member deployed is effected by extending the body and inner rod together, preferably with no relative axial movement, in the axial direction.

23. The apparatus of claim 12, wherein said stretch rod assembly is extendible into said parison in use, and wherein the controller is configured cause the stretch rod assembly with said at least one deployable member deployed to push the stretched end of the parison onto the bottom surface of the mould cavity.

24. The apparatus of claim 2, wherein the lateral span between the ends of the deployable members when deployed substantially matches the dimensions of the bottom surface of the mould cavity.

25. The apparatus of claim 12, wherein said controller is configured to cause said fluid injector to inject fluid into said parison simultaneously with the extension of said stretch-rod assembly in the axial direction and/or the deployment of said at least one deployable member.

26. The apparatus of claim 1, wherein said parison is located, in use, in a mould cavity of said mould and said stretch rod assembly is extendible into said parison, said stretch rod assembly and said fluid injector being operable to cause the parison to conform to the shape and dimensions of the mould cavity, and wherein, preferably, said stretch rod assembly is operable to push the end of said parison onto a bottom surface of the mould cavity, preferably with said at least one deployable member deployed, and preferably with the end of said at least one deployable member in engagement with the end of the parison.

27-29. (canceled)

30. A stretch rod assembly for a stretch blow moulding apparatus, the stretch rod assembly comprising a body and at least one deployable member located at a free end of said body, said body and said at least one deployable member being movable in an axial direction and said at least one deployable member being deployable laterally from said axial direction.

31. A stretch blow moulding method for forming an article from a parison using a mould and an apparatus as claimed in claim 1, the method comprising:
extending the stretch rod assembly into the parison in said axial direction;
injecting pressurised fluid into said parison;
positioning said at least one deployable member to engage with an end of said parison; and
deploying said at least one deployable member to stretch said base of said parison.
